(19) United States
(12) Patent Application Publication
(10) Pub. No.: US 2010/0005461 A1
(43) Pub. Date: Jan. 7, 2010

(54) METHOD AND APPARATUS FOR CENTRALLY MANAGING APPLIANCE LANDSCAPE

(75) Inventors: Aidan Shribman, Tel Aviv (IL); Nadav Helfman, Binyamina (IL); Michael Groys, Tel Aviv (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: SAP Portals Israel Ltd., Ra'anana (IL)

(21) Appl. No.: 12/166,327

(22) Filed: Jul. 2, 2008

(51) Int. Cl. G06F 9/445

(52) U.S. Cl. 717/177; 717/174

(57) ABSTRACT

A method and apparatus for remotely installing and managing computerized landscape of soft appliances in automatic and secure manner.

A repository of components, units and resources required for all appliances is created. Then for each appliance, an appliance definition is created using a user interface component. An appliance object is created based on the definition, and an installation or management program or script is automatically generated according to the appliance object.

Installation can be fully automatic, in which operating system resources and components and other units are transferred to the installed appliance, or semi-automatic in which the installing person has to provide the required media for the components.

Certificates are created and transferred to the installing person, and then used during installation of secure parts of the appliance.

### TECHNICAL FIELD

The present disclosure relates to distributed computerized landscape in general, and to a method and apparatus for centrally installing and managing a landscape comprising multiple appliances, in particular.

### BACKGROUND

Many organizations or environments employ a network comprising multiple soft appliances optionally situated in regional offices, and one or more principal stations, such as example data centers. A data center is a geographical location in which multiple computing platforms are located, taken care of by skilled personnel, and providing services to multiple distributed remote locations and users. A regional office or a remote office is a geographic location, such as the offices of an organization in a location other than the main IT center. A soft appliance is defined as a software application combined with just enough operating system (JeOS) for it to run optimally on standard hardware (such as a server) or on a virtual machine. A soft appliance is thus a “total” solution comprising an industry-standard hardware, a tailored operating system optimally customized for the defined task, and dedicated software applications or components. Soft appliances are generally used in order to reduce the Total Cost of Ownership (TCO) of the owner, by eliminating the extra logistics associated with dedicated or vendor-provided hardware on one hand, and the installation, administration and maintenance costs associated with pure software application solutions on the other hand.

TCO considerations gain further significance when the computerized landscape is a distributed computerized network, in which multiple soft appliances, possibly located in multiple geographic locations, are required to perform one or more tasks.

A vendor providing a software appliance based solution generally faces a number of challenges. First, the vendor has to cover all installation, certification, update, monitoring, and maintenance aspects of the product in a cost effective way, while complying with the customer's requirements and service standards, including security arrangements. Second, the vendor has to support multiple hardware configurations, operating systems or versions thereof, according to the customer's requirements. Third, the software appliance may have to be installed, configured, or maintained differently according to user's identity, geographic location, role, privileges, or other factors. The above challenges are further intensified when the appliances are located in multiple geographic locations, some of which may suffer from insufficient or under skilled IT resources and personnel.

Known products or techniques for soft appliance maintenance include remote administration of general purpose servers and workstations, and image based life-cycle management.

The remote administration approach is operating-system, or even operating-system-version specific, and has significant overhead when the soft appliances are relatively simple and inexpensive.

The image based solutions, on the other hand, require manual generation of multiple images, for any combination of hardware configuration, operating system version and product profile, thus consuming significant storage space and significant network resources during transmission.

There is thus a need in the art for a solution for installing, updating, and maintaining multiple soft appliances in a geographically distributed computerized landscape. The solution should provide for low TCO, while providing secure and efficient service, and eliminating the need for skilled IT personnel at each geographic location of the landscape.

### SUMMARY

A system and method for installing and maintaining soft appliances from a server which may be remote, with little or no intervention of personnel, and particularly professional personnel at the remote location. Installation and management can be performed in an automatic manner, wherein operating system components and applications are downloaded from the server, or in semi-automatic manner wherein the user is instructed which media to supply for installation.

In some embodiments, there is thus provided in a distributed computer network comprising one or more servers and one or more appliances, a method for remotely managing the appliances based on a policy, the method comprising the steps of: receiving an appliance definition for each appliance; creating a management component based on the appliance definition; creating one or more certificates associated with the appliance; supplying the certificates to a user; executing the management component; and using the certificates for installing the appliance. Within the method, the management component can install the appliance in an automatic manner, excluding a step of supplying a password by a user. Within the method, the management component can require a user to introduce media to the appliance during execution of the management component. The method can further comprise a step of installing an operating system on the appliance. Within the method, the management component is optionally created automatically. The method can further comprise the steps of: storing an installation component or resource; and incorporating a reference to the installation component or resource into the management component. Within the method, the appliance definition optionally follows the policy. The policy optionally comprises one or more items selected from the group consisting of: the appliance type; the appliance location; one or more requirements from the appliance; performance required from the appliance; available hardware; available resources, one or more security requirements from the appliance; or available personnel. The method can further comprise the step of creating an appliance object file comprising one or more of the certificates, based on the appliance definition. Within the method, the appliance object definition is optionally supplied using a secure protocol. Within the method, the appliance object definition is optionally supplied using a method selected from the group consisting of: e-mail; text message; short message service; facsimile; telephone; network service; and a storage media. Within the method the management component is optionally a maintenance program, an installation program, a maintenance script, or an installation script. Within the method, the appliance is optionally a software appliance.

Another aspect of the disclosure relates to an apparatus for remotely managing one or more appliances based on a policy, in a distributed computer network, the apparatus comprising components executed on one or more computing platforms within the distributed computer network, the components comprising: an appliance definition component, the appliance definition component comprising: a user interface for defining appliance attributes; and an appliance object creating component, for creating an appliance object based on the appliance attributes; a management program generation component for generating a management program for the appliance; and an appliance installation or management execution component for executing the management program. The apparatus can further comprise a certificate generation component for generating one or more certificates for secure installation or management of the appliances. Within the apparatus, the appliance installation or management component optionally comprises: a communication component for communicating with a second computing platform, the communication component comprising a non-secure communication component; and a program or script retrieval component for retrieving a program or script based on the appliances. Within the apparatus, the appliance installation or management component can further comprise a unit retrieval component for retrieving units referenced by the management program. Within the apparatus, the communication communication component can further comprise a secure communication component for communicating in a secure manner with the second computing platform. Within the apparatus, the management program is optionally a maintenance program, an installation program, a maintenance script, or an installation script.

Yet another aspect of the disclosure relates to a computer readable storage medium containing a set of instructions for a general purpose computer, the set of instructions comprising: receiving an appliance definition for one or more appliances; creating a management component based on the appliance definition; creating one or more certificates associated with the appliance; executing the management component; and using the certificates for installing the appliance.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is a schematic illustration of typical environment in which the disclosed apparatus is used;

FIG. 2 is a flowchart showing the main steps in a method according to the disclosure; and

FIG. 3 is a block diagram of an apparatus for installing and maintaining soft appliance within a distributed network, in accordance with the disclosure.

### DETAILED DESCRIPTION

The disclosure relates to U.S. patent application Ser. No. 10/498,409 filed on Dec. 6, 2004, which is a national phase of International patent application number PCT/IL02/00991 filed on Dec. 9, 2002 assigned to the assignee of the disclosed application, and to U.S. patent application Ser. No. 11/389,890, filed on Mar. 27, 2006 assigned to the assignee of the disclosed application, the full contents of both applications is herein incorporated by reference.

The disclosed method and apparatus offer a policy-based management system for soft appliances within a distributed computerized landscape of an organization. A soft appliance generally comprises a software application executed on a standard computing platform, such as a server, having the minimal operating system (OS) capabilities which enable the execution of the application. A soft appliance can be used, for example, as a file server, a firewall station, a router, a Virtual Private Network (VPN) server, a media center, or the like.

In accordance with the disclosure, a repository is created which stores all data, including operating systems versions, application versions, security components and others, are required for installing and managing the appliances. The repository is associated with a server accessible from all locations at which software appliances are to be installed and maintained, such as but not limited to regional offices.

Then, for each type of appliance to be installed, a definition is constructed, based on the required operating system (OS) and version thereof the appliance type, applications, user identity, role, security components or the like.

Once the definition is completed, an appliance object definition is created, and a management component, such as an installation or maintenance program or script is generated, relating to all aspects of the installation and maintenance, including operating system installation and maintenance, application installation and maintenance, and additional steps if required. The repository thus comprises installation and maintenance scripts, data, and resources for all types of software appliances to be installed and maintained. The appliance object definition comprises certificates and additional data required for installing the appliance. The certificates and additional data are optionally generated for each appliance to be installed, and may contain secure data. The management component, such as the installation program or script is then used for automatic or semi-automatic installation at the remote location. An automatic installation is used when the user introduces a kickstart media, such as the first operating system installation disk to the standard hardware, and indicates a Uniform Resource Identifier (URI) of the server from which installation is to continue. The system then access the u, receives installation instructions and the media, such as the required files, and completes the installation without further user intervention. A semi automatic installation also starts by the user introducing a kickstart media and a URI, but the installation process involves the transfer of instructions to the appliance and to the user, without sending the installation media itself. Thus, the installation may comprise steps like presenting to a user an instruction indicating “insert media XXX”, and installation can continue only after the user complies with the instructions.

Having the repository of all installation programs or scripts and all required components, enables for automatic or semi-automatic installation and maintenance of remote appliances according to a uniform policy, without requiring professional personnel at the remote locations

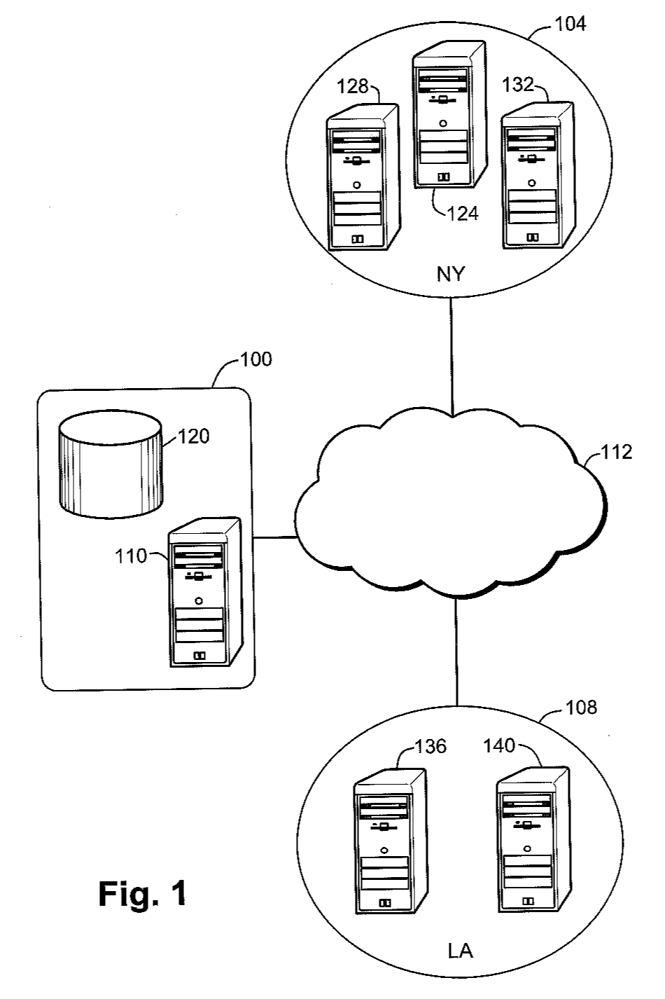

Referring now to FIG. 1, showing a typical environment in which the disclosed method and apparatus are used. The environment comprises a management server located at a data center 100, and two remote offices, being New York site 104 and Los Angeles site 108. Management server 100 and sites 104 and 108 are connected through communication channel 112, such as the internet, Intranet, Wide Area Network (WAN) or others. Management server 100 comprises a computing platform 110, which can be any computing platform, such as a mainframe computer, a desktop computer, or any other computing platform provisioned with a CPU and memory unit. The server further comprises or has access to a storage unit 120, storing a repository of all installation components, operating system components, application components, scripts, programs and other units. The repository is optionally arranged as one or more folders, such as a network exposed HTTP or HTTPS folder of folder hierarchy. Storage unit 120 can be a mass storage device, for example an optical storage device such as a CD, a DVD, or a laser disk; a magnetic storage device such as a tape or a hard disk; a semiconductor storage device such as Flash device, memory stick, or the like.

Each of remote offices 104 and 108 comprises a multiplicity of soft appliances to be installed and maintained, such as appliances 124, 128, or 132 of site 104, or appliances 136, or 140 of site 108. The appliances can be defined to be of the same type or of multiple types, wherein the repository stored on storage device 120 contains installation programs and components for all relevant appliance types. Each appliance optionally executes an unattended network-based operating system, in order to minimize required IT personnel.

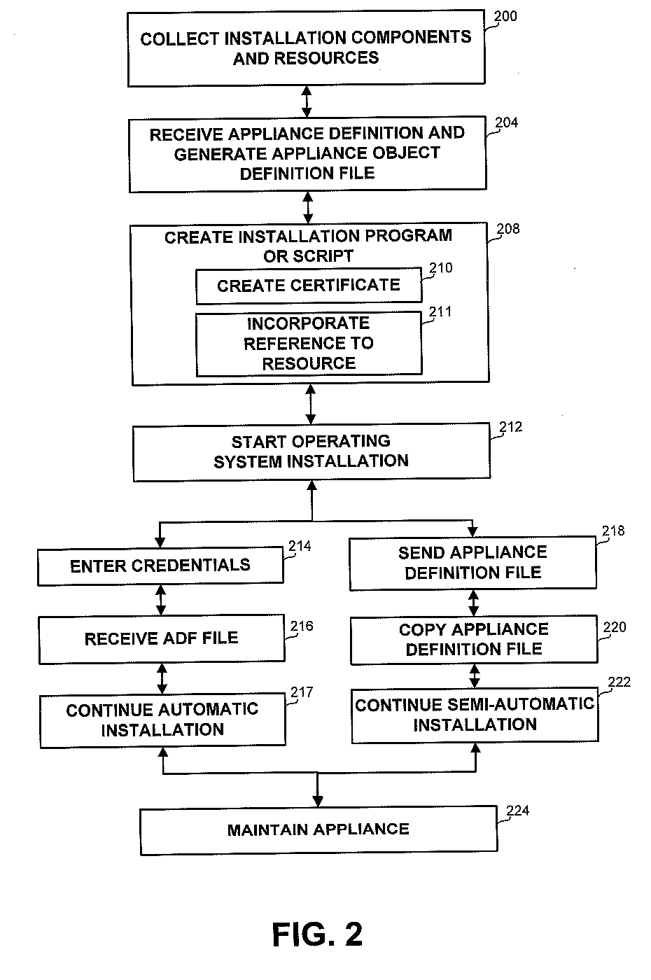

Referring now to FIG. 2, showing a flowchart of the main steps in the method of the disclosure. On step 200, all installation components and resources, including operating system components, application components and the like are collected or gathered and stored in a repository accessible by server 110 of FIG. 1. The repository stores all data, including operating systems versions, application versions, security components and others, which are used for managing and installing the appliances.

On step 204 one or more appliances are modeled to create an appliance object definition file. Each object is defined by a user in terms of any combination of the related appliance attributes and characteristics, including but not limited to the underlying hardware, required operating system, application roles, host configurations, security credentials, geographic location, supported user roles, or other details. The security credentials are optionally automatically generated and may uniquely identify each appliance in the landscape. The uniqueness allows to authentication and authorization of appliances in the landscape. The appliances are optionally defined according to an organization policy. In some embodiments, appliance definition may utilize template generation. Templates are optionally pre-configured appliance definition blueprints from which new appliance definitions are d. The usage of templates is useful since some of the appliance attributes are common and are therefore set correctly a-priori. Once definition is complete, the definition is received by the system as plain text, L, binary file, database entities, or the like.

On step 208, a management component, such as an installation or management program or script is automatically generated for each appliance from the generated appliance object. A kickstart file, which enables automatic initiation of an installation process is generated automatically for platforms and operating system combinations that support automatic installation. Optionally, as part of the program or script generation, a certificate is created on step 210, which may later be used for the secure parts of the installation. An appliance definition file is generated as well which contains additional configuration parameters and the certificates required for the installation of application components.

Each installation program or script can be generated to enable fully automatic or semi-automatic installation. If a fully-automatic installation program or script is generated, references to resources, such as operating system components, application components, or other components are incorporated in the installation program or script on optional step 211. Optionally, for each appliance, a fully automatic installation program or script is generated, as well as a semi-automatic version. Alternatively, and depending on the operating system attributes and on the required installations, only the fully automatic or only the semi automatic program or script can be generated. Each installation program or script includes automated tailored installation instructions, operating system configuration, application configuration, and configurations for all related components which are integrated in the appliance solution.

In the case of fully automatic installation, in which all components are transferred during the installation to the appliance, a locator indicating the location of the installation program or script such as a Universal Resource Identifier (URI) or a Universal Resource Locator (URL) is made available to one or more persons that have to install the associated appliances. Additionally, the installation program or script includes or points at addresses at which the relevant components are available.

In the case of semi-automatic installation, the program or script may comprise indications to be displayed to the installer where to get the components from, for example “insert third disk of operating system installation”, and instructions to the appliance how to access the required resources, but the process will require some user interaction.

The appliance object definition file and a kickstart file prepared for automatic installations are optionally text files having a pre-determined structure, and are made unique by embedding therein values extracted from the central appliance definition. Once appliances for the landscape are defined, and scripts or programs are generated, appliances within the landscape can be installed, monitored or maintained.

On step 212, appliance installation starts by installing the operating system. In the automatic installation case, wherein installation is to be performed on a computer with no operation system, installation starts by the user providing the first disk of the OS. Optionally, for example under Linux OS, a URL can be provided, such as a URL of a data center, from which a kickstart file is downloaded which comprises the instructions for further installations, including the rest of the OS installation, and post-OS installations. The instructions include the source location for the required media and a list of required packages, if any. Once the OS is installed, the application installation is accessed or copied to the computer being installed. On step 214, the user has to provide a password or other credentials in order to receive the appliance object definition file, which comprises the unique certificates. On step 216 the appliance object definition file is received, optionally via a secure protocol such as HTTPS, and on step 217 the automatic installation is continued by installing the particular content required for the appliance. In some embodiments, the appliance object definition file is generated ad-hoc based on a template related to the installed components, the remote site and optionally parameters of the particular appliance being installed.

In the semi-automatic case installation continues wherein the user supplies all required media. On step 218 the appliance object definition file generated on step 210 is sent to the user, for example by e-mail, a text message, a short message, a facsimile, a telephone, a storage media, or others, so that secure parts of the installation can take place. On step 220 the user copies the appliance object definition file to the appliance. Then, on step 222 installation of the particular content required for the appliance continues.

In the automatic installation case, the non-secure parts of the installation, such as the OS installation are performed using non-secure protocol, such as HTTP, while the secure parts are performed using secure protocols such as HTTPS.

During the semi-automatic installation no connection is required between the appliance and the center, so no password is required and no HTTPS session occurs. However, the appliance is not foreign to the overall system, since the appliance object definition file required for the installation was generated specifically for the appliance, and in accordance with the requirements and characteristics of the appliance.

In both the automatic and the semi-automatic scenarios, the appliance object definition file is used for installing the appliance, whether the file was received as part of the installation, or separately.

While the disclosure was focused more on the Linux OS, a person skilled in the art will appreciate that the same principles can be applied to other operating systems, including the Windows family of operating systems.

On step 224, maintaining the appliance optionally continues throughout the life-cycle of the appliance, including backups, updates, monitoring, re-installation if required, and other activities are performed according to the scripts or programs generated on step 208.

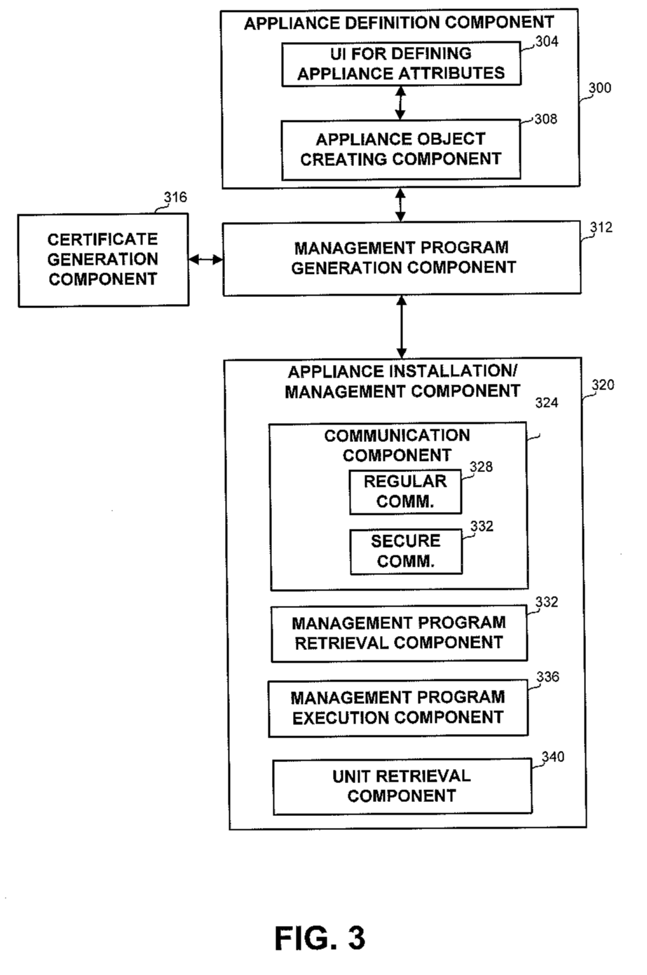

Referring now to FIG. 3, showing a block diagram of the main components in an apparatus according to the disclosure. Optionally, all components of the apparatus comprise interrelated collections of computer instructions, arranged as executables, static libraries, dynamic link libraries, modules, units or other components that can be executed by a computing platform, such as a server. The components can be programmed in any programming language, such as C#, C++, Java, C, or others, and under any development environment. The apparatus generally comprises appliance definition component 300, management program generation component 312 and appliance installation/management component 320.

Appliance definition component 300 is used by a system administrator, a system manager, a professional who has knowledge about a specific appliance, or the like. Appliance definition component 300 comprises a user-interface (UI) component 304 for defining the appliance attributes. UI component 304 optionally comprises a graphic or another interface for introducing appliance attributes, such as geographical location, available hardware, required operating system, applicative role, or others. Appliance definition component 300 further comprises component 308 for creating an appliance object based on the attributes entered by a user using UI component 304.

The apparatus further comprises management program generation component 312 for receiving the appliance definition object as generated by component 308, and generating installation, maintenance, update, monitoring or other programs, scripts or other units. The programs or scripts can be adapted for fully-automatic execution or for semi-automatic execution.

The apparatus comprises certificate generation component 316 for generating certificates for secure communication with the appliances.

For performing the installation or maintenance, the apparatus comprises appliance installation or management component 320. Appliance installation or management component 320 comprises communication component 324 for communicating with the appliance being installed or maintained. Communication component 324 optionally comprises clear-text communication component for handling non-secure communication, for example in HTTP protocol; and secure communication component for handling secure communication, for example in HTTPS protocol. Appliance installation or management component 320 further comprises management program retrieval component 332 for receiving an indication of an appliance to be installed or maintained, and retrieving the corresponding installation or maintenance program or script, management program execution component 336 for executing the retrieved installation or maintenance program or script by sending commands or instructions to the appliance, and unit retrieval component 340, for retrieving the relevant operating system component, application component, security component, or other components or units relevant for installation or maintenance. Component 340 is useful in fully automatic installation, wherein the components are sent to the appliance.

Using the disclosed method and apparatus, appliances in a distributed landscape are remotely installed, maintained and managed according to an organization policy, which takes into account the type, location, requirements, required performance, available hardware, available resources, security requirements, available personnel or other attributes associated with the appliances to be installed and maintained. The installation and maintenance require minimal footprint and minimal network resources on one hand, and minimal user intervention on the other hand, thus saving costs and improving the TCO.

It will be appreciated that the repository comprising the installation components and the installation programs and scripts can be maintained in any manner, such as a relational database, a flat collection, a hierarchic collection arranged according to appliance type, geographic location, other parameters, or any other arrangement.

In some embodiments of the apparatus and method, an enhancement made to an appliance after installation, for example updating the operating system version, can be transferred back to the server. The change can then be saved as a change in the installation program or script, or as an update in the object definition upon which an updated installation program is generated. Either way, further appliances of the same type will be handled according to updated program so the change will not have to be repeated manually for each appliance.

It will be appreciated by a person skilled in the art that multiple variations and options can be designed along the guidelines of the disclosed method, without deviating from the guidelines of the disclosure. Such variations and options are considered to be covered by the disclosure.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

1. In a distributed computer network comprising an at least one server and an at least one appliance, a method for remotely managing the at least one appliance based on a policy, the method comprising the steps of:
receiving an appliance definition for the at least one appliance;
creating a management component based on the appliance definition;
creating an at least one certificate associated with the appliance;
supplying the at least one certificate to a user;
executing the management component; and
using the at least one certificate for installing the appliance.

2. The method of claim 1 wherein the management component install the appliance in an automatic manner, excluding a step of supplying a password by a user.

3. The method of claim 1 wherein the management component requires a user to introduce media to the appliance during execution of the management component.

4. The method of claim 1 further comprising a step of installing an operating system on the appliance.

5. The method of claim 1 wherein the management component is created automatically.

6. The method of claim 1 further comprising the steps of:
storing an installation component or resource; and
incorporating a reference to the installation component or resource into the management component.

7. The method of claim 1 wherein the appliance definition follows the policy.

8. The method of claim 7 wherein the policy comprises at least one item selected from the group consisting of: the appliance type; the appliance location; an at least one requirement from the appliance; performance required from the appliance; available hardware; available resources, an at least one security requirement from the appliance; or available personnel.

9. The method of claim 1 further comprising the step of creating an appliance object definition comprising the at least one certificate, based on the appliance definition.

10. The method of claim 9 wherein the appliance object definition is supplied using a secure protocol.

11. The method of claim 9 wherein the appliance object definition is supplied using a method selected from the group consisting of: e-mail; text message; short message service; facsimile; telephone; network service; and a storage media.

12. The method of claim 1 wherein the management component is a maintenance program, an installation program, a maintenance script, or an installation script.

13. The method of claim 1 wherein the appliance is a software appliance.

14. An apparatus for remotely managing an at least one appliance based on a policy, in a distributed computer network, the apparatus comprising components executed on an at least one computing platform within the distributed computer network, the components comprising:
an appliance definition component, the appliance definition component comprising:
a user interface for defining appliance attributes; and
an appliance object creating component, for creating an appliance object based on the appliance attributes;
a management program generation component for generating a management program for the appliance; and
an appliance installation or management component comprising appliance installation or management execution component an for executing the management program.

15. The apparatus of claim 14 further comprising a certificate generation component for generating an at least one certificate for secure installation or management of the at least one appliance.

16. The apparatus of claim 14 wherein the appliance installation or management component further comprises:
a communication component for communicating with an at least one second computing platform, the communication component comprising a non-secure communication component; and
a program or script retrieval component for retrieving a program or script based on the at least one appliance.

17. The apparatus of claim 14 wherein the appliance installation or management component further comprises a unit retrieval component for retrieving at least one unit referenced by the management program.

18. The apparatus of claim 16 wherein the communication component further comprises a secure communication component for communicating in a secure manner with the at least one second computing platform.

19. The apparatus of claim 14 wherein the management program is a maintenance program, an installation program, a maintenance script, or an installation script.

20. A computer readable storage medium containing a set of instructions for a general purpose computer, the set of instructions comprising:
receiving an appliance definition for an at least one appliance;
creating a management component based on the appliance definition;
creating an at least one certificate associated with the appliance;
executing the management component; and
using the at least one certificate for installing the appliance.
